(19) United States
(12) Patent Application Publication
(10) Pub. No.: US 2007/0180726 A1
(43) Pub. Date: Aug. 9, 2007

(54) Tape measure holster system and method

(76) Inventor: Paul Wesley Harrell, Spartanburg, SC (US)

Correspondence Address: Thomas L. Moses;Monahan & Moses, LLC, 13-B West Washington St., Greenville, SC, 29601, US

(21) Appl. No.: 11/351,195

(22) Filed: Feb. 9, 2006

(51) Int. Cl. G01B 3/10

(52) U.S. Cl. 33/760

(57) ABSTRACT

A tape measure and a holster system and method, where the holster is made from a generally rectangular strip of durable material formed into a loop on an upper end for attachment to a user's belt, and formed into a pocket on a lower end to receive the clip member of a tape measure. The loop may include a hook and loop attachment means, a button, snap, or other temporary attachment means instead of the permanent stitching, so that the user may open and close the loop at his or her convenience. This optional feature allows a user to attach the loop to a belt without having to unbuckle or unfasten the belt as it is being worn. At the lower end, the strip is folded into a pocket for receiving the tape measure clip, and the pocket portion is stitched along the edges of the folded strip in a longitudinal direction. Preferably, the lip of the pocket is folded inwardly one time, to increase the rigidity of the pocket lip and to prevent fraying. From each edge of the lip, a stitch may be sewn downwardly at an angle to form a U-shape or a V-shape, which acts as a guide for the clip of the tape measure, so that the tape measure may be positioned centrally within the pocket member of the holster.

### BACKGROUND OF THE INVENTION

1. Field of the Invention

It is common for tools such as tape measures to have a clip attached thereto, so that the tool may be clipped to a user's waist, belt or pocket. One problem commonly associated with such clips is that they tend to tear up the area of clothing where they are attached. Further, the tool has a tendency to become detached from the user when they sit down or during the normal activity associated with construction work. The present invention relates to an improved tape measure and holster system for removably attaching a tape measure having a clip to a user's belt or waist. More specifically, the present invention pertains to a tape measure and a holster system, where the holster is made from a generally rectangular strip of flexible, durable material formed into a loop on an upper end for attachment to a user's belt, and formed into a pocket on a lower end to receive the clip member of a tape measure.

2. Description of the Art

The use of holsters to attach various tools to a user's belt or waist is disclosed in the following documents. U.S. Pat. No. 4,757,927 pertains to a holder for suspending a rule clip or the like. U.S. Pat. No. 4,821,933 is directed to a leather tape rule holder. U.S. Pat. No. 5,450,994 discloses a measuring tape holder with a notched back panel and riveted clip means. Published U.S. Patent Application No. US 2004/0124220 A1 is directed to a rigid tool holder with a guide plate for mounting tools having spring clips. In this disclosure, the guide plate is above the clip holder, and does not extend into the clip holder, where the sides are in parallel relation. Published U.S. Patent Application No. US 2004/0140337 A1 discloses a belt clip extension for personal use devices. All of the United States patents cited in this application are hereby incorporated by reference.

Each of the devices described in the above publications has certain disadvantages, including difficulty and expense in manufacturing and lack of user comfort, among other problems. Therefore, it can be appreciated that a need exists for an improved tape measure holster system that is relatively simple and inexpensive to manufacture, is comfortable for a user to wear, and avoids other disadvantages of the above-mentioned devices.

### SUMMARY OF THE INVENTION

In view of the foregoing disadvantages inherent in the known types of holders present in the prior art, it is an object of the present invention to provide an improved tape measure holster system that includes the advantages of the prior art while avoiding the disadvantages. The general purpose of the present invention is to provide a tape measure holster system that may be secured to a user's belt, allowing a user to removably attach a tape measure to the holster.

The holster system includes a generally rectangular strip of durable material formed into a loop on an upper end for attachment to a user's belt, and a pocket on a lower end for receiving the clip of a tape measure. The holster may be formed by folding a single strip of the durable material to form a loop at the top end, and stitching the end of the strip to the body of the strip, so that the stitching is directed transversely across the strip of material. Alternatively, the loop may include a hook and loop attachment means, a button, snap, or other temporary attachment means instead of the permanent stitching, so that the user may open and close the loop at his or her convenience. This optional feature allows a user to attach the loop to a belt without having to unbuckle or unfasten the belt as it is being worn. At the lower end, the strip is folded into a pocket for receiving the tape measure clip, and the pocket portion is stitched along the edges of the folded strip in a longitudinal direction. Preferably, the lip of the pocket is folded inwardly one time, to increase the rigidity of the pocket lip and to prevent fraying. From each edge of the lip, a stitch may be sewn downwardly at an angle to form a V-shape, which acts as a guide for the clip of the tape measure, so that the tape measure may be positioned centrally within the pocket portion of the holster. This arrangement also allows tape measures of different sizes (and tape measures having clips of different sizes) to be secured within the pocket portion. Further, the tape measure is less likely to pivot or slide within the pocket with the V-shaped guide, which is particularly advantageous if a user wishes to extend the tape from the tape measure for a measurement while the tape measure is still secured within the holster.

On the front face of the loop member above the pocket, advertisements may be displayed in any suitable manner, including through embroidery, printing, or by having removable advertisement patches releasably secured to the loop member by a releasable attachment means, such as hook and loop fastening material.

### BRIEF DESCRIPTION OF THE DRAWINGS

These and other features, aspects, and advantages of the present invention will become better understood with regard to the following description, appended claims, and accompanying drawings where:

FIG. 1 is a perspective view of the tape measure holster having a loop member on an upper end and a pocket member on a lower end;

FIG. 2 is a side view of the tape measure holster in use in combination with a tape measure having a clip member;

FIG. 3 is a frontal view of the tape measure holster including the V-shaped clip guide; and

FIG. 4 is a frontal view of the tape measure holster including the U-shaped clip guide.

### DETAILED DESCRIPTION OF THE INVENTION

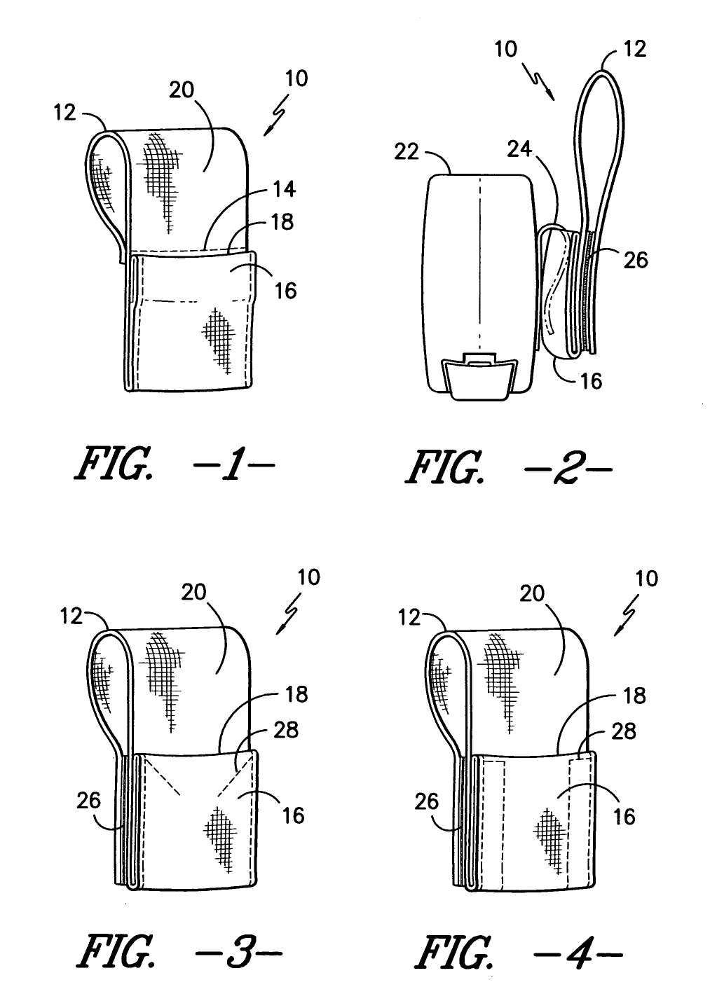

A first embodiment of the tape measure holster is shown in FIG. 1. The holster 10 is made from a single strip of flexible, durable material that is folded to form the loop member 12 on an upper end thereof. The material is attached to itself in order to form a loop, preferably by providing stitching 14 that is disposed across a transverse line adjacent the bottom of the loop member 12, although any other suitable attachment means may be used.

In one preferred embodiment, the material used to make the tape measure holster is a webbing of nylon, polyester, or a combination thereof. On a bottom portion of the tape measure holster, the strip is folded onto itself and attached thereto in order to form a pocket member 16, preferably by providing a stitch on either side of the pocket member running in a longitudinal direction, and allowing an opening at the top of the pocket 16. In a preferred embodiment, the top of the pocket member is folded inwardly and downwardly, so that the lip portion 18 of the pocket member is a folded crease in the material. This arrangement provides more rigidity for the lip of the pocket for ease of attachment to the tape measure clip, and reduces the chances of fraying along the lip 18.

Alternatively, as shown in FIGS. 2 and 3, the pocket member may be folded in such a way that the layer of material inside the pocket extends down to the bottom of the pocket, to provide extra rigidity and thickness therethrough. This alternative, and potentially preferred, arrangement provides a thicker layer for insertion within the clip of the tape measure that extends throughout the pocket, which facilitates placement of the clip onto the pocket, as well as removal of the clip therefrom.

FIG. 2 shows the tape measure holster system in use, where a tape measure 22 includes a clip member 24, which is disposed within the pocket member 16 of the holster 10. The tape measure may be easily attached to the holster and removed by sliding the clip into or out of the pocket member. This arrangement also allows a user to extend the tape from the tape measure while the tape measure is attached to the holster, thereby freeing the user's hands from the burden of holding the tape measure in place for measurement.

As shown in FIG. 3, from each edge of the lip 18, a diagonal stitch 28 may be sewn downwardly at an angle to form a V-shape, which acts as a guide for the clip of the tape measure, so that the tape measure may be positioned centrally within the pocket portion of the holster. In one embodiment, the V-shaped guide is sewn so that the bottom of the V is disposed approximately halfway up the clip member when the clip is secured within the pocket, as shown in FIG. 3. This arrangement also allows tape measures of different sizes (and tape measures having clips of different sizes) to be secured within the pocket portion, and also provides a weight balance as the tape measure is secured to the holster. Further, the tape measure is less likely to pivot or slide within the pocket having the V-shaped guide, which is particularly advantageous if a user wishes to extend the tape from the tape measure for a measurement while the tape measure is still secured within the holster. In some cases, however, it may be desirable to position the bottom of the V-shaped guide adjacent the bottom of a tape measure clip when the clip is disposed within the pocket. Indeed, it is contemplated that many different arrangements may be desirable for the V-shaped guide, so long as the guide serves to position the tape measure centrally within the holster.

FIG. 4 shows another potentially preferred embodiment of the tape measure holster, wherein the pocket member has a U-shaped guide member. The U-shaped guide member is preferably a pair of stitches running longitudinally along each side of the pocket member from the top of the pocket to the bottom. These stitches are positioned inwardly from each longitudinal edge of the holster, and provide a pocket width that is broad enough to accept the insertion of the clip from a tape measure. This arrangement provides increased strength so that the pocket does not begin to pull away from the body of the holster. Further, the U-shaped guide is used to position the clip and the tape measure in the center of the holster, which is advantageous for the reasons set forth in favor of the V-shaped guide above.

Although the tape measure holster may be manufactured in different sizes to accommodate different sizes and types of tape measures, one preferred embodiment of the holster measures approximately 1¾ inches in a transverse direction and approximately 3½ inches in a longitudinal direction. This size allows the holster to provide a sufficient buffer area to prevent the tape measure, which may become soiled in normal construction type activities, from coming into contact with a user's pants. In this embodiment, the pocket member of the holster is approximately 1½ inches deep, allowing for a variety of sized tape measure clips, and the loop member is approximately 2 inches from top to bottom, which should accommodate most standard sized belts.

In an alternate embodiment, advertising material may be disposed on an outer portion 20 of the loop member 12. Such advertising may be printed, embroidered, painted, or affixed in any other suitable manner. One alternate embodiment may include removable advertising that is affixed to a patch having a hook and loop fastener on a backside thereof, which may be attached to a hook and loop fastener attached to the outer portion of the loop member.

In another alternate embodiment, the loop member 12 may be attached by releasable means 26, such as with hook and loop fastening material, snaps, buttons or in some other conventional manner, as shown in FIGS. 2 and 3. This arrangement allows a user to attach the tape measure holster to a belt (or detach the holster from the belt) while the belt is in place about a user's pants or body, without having to unbuckle or otherwise unfasten the belt. A user may simply detach the loop from the main body of the tape measure holster, slide the upper end of the material around the user's belt, and then reattach the end of the loop member to the main body of the holster, thus reforming the loop with the belt disposed therein.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. A tape measure holster system comprising:
a tape measure having a belt clip; and
a holster made from a single strip of flexible, durable material folded on an upper end to form a loop member for inserting a belt therethrough, and said strip folded on a lower end to form a pocket member for receiving said belt clip of said tape measure.

2. The tape measure holster system set forth in claim 1, wherein said flexible, durable material is polyester, nylon, or some combination thereof.

3. The tape measure holster system set forth in claim 1, wherein said loop member is releasably attached to itself by a releasable attachment means.

4. The tape measure holster system set forth in claim 3, wherein said attachment means comprises hook and loop fastening material, buttons or snaps.

5. The tape measure holster system set forth in claim 1, wherein said loop member and said pocket member are secured by stitching.

6. The tape measure holster system set forth in claim 1, wherein said pocket member includes a U-shaped or a V-shaped guide that serves to center said clip and said tape measure with respect to said tape measure holster.

7. The tape measure holster system set forth in claim 6, wherein said U-shaped guide or said V-shaped guide is formed by stitching.

8. The tape measure holster system set forth in claim 1, wherein said loop member includes advertising information.

9. The tape measure holster system set forth in claim 8, wherein said advertising information is embroidered or printed on said loop member.

10. The tape measure holster system set forth in claim 8, wherein said advertising information is printed on a removable patch that is releasably secured to said loop member through releasable attachment means.

11. The tape measure holster system set forth in claim 10, wherein said releasable attachment means includes hook and loop fasteners, buttons, or snaps.

12. The tape measure holster system set forth in claim 1, wherein said pocket member includes a folded lip.

13. A process for attaching a tape measure to a user's belt, said process comprising the steps of:
providing a strip of flexible durable material;
folding one end of said strip material back onto itself to form a loop member suitable for a belt to pass therethrough;
folding an opposite end of said strip material back onto itself and attaching said opposite end of said material to itself in to form a pocket member;
threading a belt through said loop member and attaching said belt to a user's waist; and
attaching a tape measure having a belt clip to said pocket member by sliding said belt clip into said pocket member, thereby securing said tape measure to said user's waist.

14. The process set forth in claim 13, further including the step of providing a U-shaped guide or a V-shaped guide within said pocket member that serves to center said clip and said tape measure with respect to said tape measure holster.

15. The process set forth in claim 13, further including the step of providing releasable attachment means for said loop member, so that said loop may be releasably attached to itself.

16. The process set forth in claim 13, further including the step of providing advertising information on an outer portion of said loop member.

17. The process set forth in claim 13, further including the step of folding said pocket member to form a crease at a lip portion of said pocket member to provide extra rigidity and to prevent fraying.

18. The process set forth in claim 13, wherein said loop member is formed by stitching said material together in a lateral direction.

19. The process set forth in claim 13, wherein said pocket member is formed by stitching said material together in a transverse direction.

20. The process set forth in claim 13, including the step of weaving said strip of durable, flexible material from polyester, nylon, or a combination thereof.
